(19) United States
(12) Patent Application Publication
(10) Pub. No.: US 2023/0279229 A1
(43) Pub. Date: Sep. 7, 2023

(54) HYBRID ACOUSTIC DAMPING LAYER

(71) Applicant: Wolverine Advanced Materials, LLC, Dearborn, MI (US)

(72) Inventor: Craig Bryant JAYNES, Bloomfield Hills, MI (US)

(21) Appl. No.: 18/171,210

(22) Filed: Feb. 17, 2023

Related U.S. Application Data
(62) Division of application No. 16/577,893, filed on Sep. 20, 2019, now abandoned.

(51) Int. Cl. C08L 83/04; C08L 33/08; B05D 1/28; F16D 65/00; B05D 3/10; C08L 75/06

(52) U.S. Cl. CPC C08L 83/04; B05D 1/286; B05D 3/108; C08L 33/08; C08L 75/06; F16D 65/0006

(57) ABSTRACT

Technologies are generally described for hybrid acoustic damping materials that may be used in noise, vibration, and harshness mitigation. In some examples, solvated acrylic, silicone, and/or urethane materials may be blended in selected proportions to form a hybrid acoustic damping material. Characteristics of the components of the hybrid acoustic damping material such as viscosity and proportions may be selected for a desired composite loss factor vs. temperature characteristic of the material. In some examples, a broad temperature range of damping or a targeted temperature region may be achieved based on the composition of the hybrid acoustic damping material. To achieve a uniform stable blend with a consistent viscosity, individual component materials may be selected with similar molecular weight/viscosity. Compatible solvents may be added during blending of the components. In various example applications, the hybrid acoustic damping material may be used in vehicle brake applications to reduce brake noise/vibration.

### BACKGROUND

Unless otherwise indicated herein, the materials described in this section are not prior art to the claims in this application and are not admitted as prior art by inclusion in this section.

One of the sources of noise and vibration characteristics of vehicles, particularly cars and trucks, is vibration and/or squealing noise created by the brakes. To mitigate noise and vibration (also referred to as Noise, Vibration, and Harshness “NVH”), layered materials can be used to absorb audible vibration energy and damp the noise from reaching the occupants of the vehicle.

### SUMMARY

The present disclosure generally describes hybrid acoustic damping layers for noise, vibration, and harshness mitigation.

According to some examples, a hybrid acoustic damping material is described. The hybrid acoustic damping material may include a first component comprising a solvated acrylic polymer or a solvated acrylic-urethane polymer and a second component comprising a solvated silicone polymer. The first component and the second component may be mixed in a blend in liquid form; a percent solids concentration of the first component and a percent solids concentration of the second component may be within about 15% of one another; and the dried blend may be cured to form the hybrid acoustic damping material.

According to other examples, the second component may be a polysiloxane polymer and a volumetric proportion of the second component in the blend may be in a range from about 5% to about 95%. The second component may be an oligosiloxane polymer and a volumetric proportion of the second component in the blend may be in a range from about 5% to about 30%. A proportion of the first component may be increased in a range from about 5% to about 95% in the blend to increase a composite loss factor of the hybrid acoustic damping material at a lower temperature within an operating temperature range of the hybrid acoustic damping material. A proportion of the second component may be increased in a range from about 5% to about 95% in the blend to increase a composite loss factor of the hybrid acoustic damping material at a higher temperature within an operating temperature range of the hybrid acoustic damping material. The hybrid acoustic damping material may further include a crosslinker, a catalyst, or a preservative in the blend.

According to further examples, a damping element for brake systems is described. The damping element may include a transfer film that includes a removable film and a damping layer disposed on the removable film, where the damping layer may include a cured blend of a first component and a second component. The first component may include one or more of a solvated acrylic polymer or a solvated acrylic-urethane polymer, the second component may include a solvated silicone polymer, and a percent solids concentration level of the first component and a percent solids concentration level of the second component may be within about 15% of one another.

According to yet other examples, the second component may be a polysiloxane polymer, and a volumetric proportion of the second component in the blend relative to a volumetric proportion of the first component may be in a range from about 5% to about 95%. The second component may be an oligosiloxane polymer, and a volumetric proportion of the second component relative to a volumetric proportion of the first component in the blend may be in a range from about 5% to about 30%. One or more of a type of the first component, a type of the second component, a proportion of the first component or the second component, a solid concentration of the first component, and a solid concentration of the second component may be selected based on one or more of a brake system type, a vehicle type, or a brake material type. The brake system type may be a disk brake and the brake material type may include one or more of ceramic, composite, or metal combination materials. The damping material may be adapted for use in a light weight vehicle or a heavy weight vehicle. The damping layer may be configured to be applied to one or more of an outside surface or an inside surface of an anti-squeal shim.

According to some examples, a method to form a hybrid acoustic damping material is described. The method may include selecting a first component comprising one or more of a solvated acrylic polymer or a solvated acrylic-urethane polymer; selecting a second component comprising a solvated silicone polymer, wherein the second component is selected such that a percent solids concentration of the first component and a percent solids concentration of the second component are within about 15% of each other; blending the first component and the second component in liquid form; removing one or more solvents from the blended first component and second component in liquid form; and curing the blended first component and second component.

According to other examples, selecting the second component may include selecting a polysiloxane polymer; and selecting a volumetric proportion of the second component relative to a volumetric proportion of the first component in a range from about 5% to about 95%. Selecting the second component may include selecting an oligosiloxane polymer; and selecting a volumetric proportion of the second component relative to a volumetric proportion of the first component in a range from about 5% to about 30%. The method may further include increasing a proportion of the first component in a range from about 5% to about 95% in the blend to increase a composite loss factor of the hybrid acoustic damping material at a lower temperature within an operating temperature range of the hybrid acoustic damping material; and increasing a proportion of the second component in a range from about 5% to about 95% in the blend to increase a composite loss factor of the hybrid acoustic damping material at a higher temperature within an operating temperature range of the hybrid acoustic damping material. Blending the first component and the second component may include adding one or more of a crosslinker, a catalyst, or a preservative to the blended first component and second component in liquid form.

According to further examples, a system to form a hybrid acoustic damping material is described. The system may include a mixing module configured to select a first component comprising one or more of a solvated acrylic polymer or a solvated acrylic-urethane polymer; select a second component comprising a solvated silicone polymer, where the second component is selected such that a percent solids concentration of the first component and a percent solids concentration of the second component are within about 15% of one another; and mix the first component and the second component to form a liquid blend. The system may also include a coating module configured to coat a shim substrate with the liquid blend; remove one or more solvents from the liquid blend; and cure the liquid blend to form the hybrid acoustic damping material.

According to yet other examples, the coating module may be further configured to dispose the hybrid acoustic damping material on a removable film to create a transfer film. The mixing module may be configured to select a polysiloxane polymer or an oligosiloxane polymer; if the polysiloxane polymer is selected, adjust a volumetric proportion of the second component relative to a volumetric proportion of the first component in a range from about 5% to about 95%; and if the oligosiloxane polymer is selected, adjust the volumetric proportion of the second component relative to the volumetric proportion of the first component in a range from about 5% to about 30%. The mixing module may be further configured to increase a proportion of the first component in a range from about 5% to about 95% in the blend to increase a composite loss factor of the hybrid acoustic damping material at a lower temperature within an operating temperature range of the hybrid acoustic damping material; or increase a proportion of the second component in a range from about 5% to about 95% in the blend to increase a composite loss factor of the hybrid acoustic damping material at a higher temperature within an operating temperature range of the hybrid acoustic damping material. The mixing module may be further configured to add one or more of a crosslinker, a catalyst, or a preservative to the liquid blend.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example hybrid acoustic damping material;

FIG. 2 illustrates example composite loss factor vs. temperature graphs for various hybrid acoustic damping material configurations;

FIG. 3 illustrates an example production system to produce hybrid acoustic damping materials;

FIG. 4 illustrates an example disk brake, where hybrid acoustic damping materials are used to mitigate noise and vibration; and

FIG. 5 illustrates a flowchart for production of an example hybrid acoustic damping material;

arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems and/or devices associated with hybrid acoustic damping materials for noise, vibration, and harshness mitigation.

Briefly stated, technologies are generally described for hybrid acoustic damping materials that may be used in noise, vibration, and harshness mitigation. In some examples, solvated acrylic, silicone, and/or urethane materials may be blended in selected proportions to form a hybrid acoustic damping material. Characteristics of the components of the hybrid acoustic damping material such as viscosity and proportions may be selected for a desired composite loss factor vs. temperature characteristic of the material. In some examples, a broad temperature range of damping or a targeted temperature region may be achieved based on the composition of the hybrid acoustic damping material. To achieve a uniform stable blend with a consistent viscosity, individual component materials may be selected with similar molecular weight/viscosity. Compatible solvents may be added during blending of the components. In various example applications, the hybrid acoustic damping material may be used in vehicle brake applications to reduce brake noise/vibration.

Noise, Vibration, and Harshness (NVH) generally refers to the study and mitigation of causes of noise, vibration, and harshness in various environments, for example, in vehicles. One of the sources of noise and vibration in vehicles, particularly cars and trucks, is vibration and/or squealing noise created by the brake system. NVH mitigation techniques for brake system (and others) noise and vibration may include, but are not limited to, selection of mechanical design parameters, interruption of the noise or vibration path, active noise control, and absorption of the noise or vibration energy through broad range or tuned dampers. Various rubber, acrylic polymer, and silicone polymer layers have primarily been used for absorption of the noise or vibration energy, as well as other properties beneficial to the system. Because each material has different absorption and temperature characteristics, a multi-layered approach may be used for efficient results. Such materials damp noise and vibration over limited temperature ranges and effectiveness by themselves. Many applications include multi-layered materials of same or different types. Each layer is associated with a series of processes to apply the layer to a suitable substrate.

The benefits of the presently disclosed hybrid acoustic damping material are numerous. For example, by producing a single layer of a damping materials that are blended together into a stable hybrid blend, which can be uniformly applied with standard equipment and processes, preparation steps may be reduced, and a single layer may be provided that is capable of effectively damping noise in the audible frequency range over a wide temperature. In some examples, narrower temperature ranges may be selected for specific applications by selecting characteristics and proportions of the blended materials, for example, in brake systems.

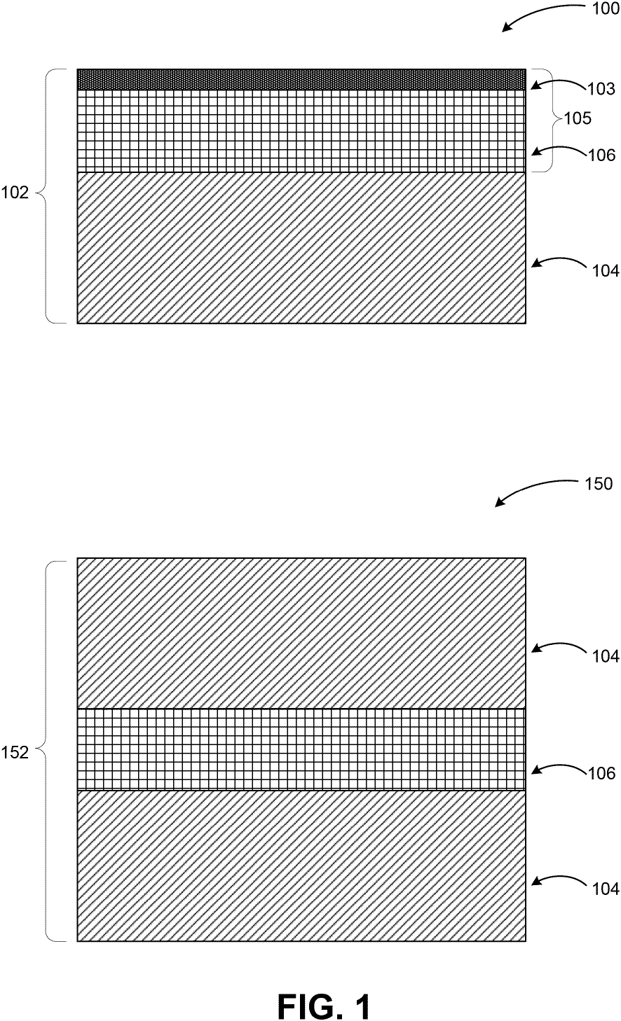

FIG. 1 illustrates an example hybrid acoustic damping material, arranged in accordance with at least some embodiments described herein.

As shown in diagram 100, a hybrid acoustic damping material 106 may be formed by blending one or more of a silicone polymer, an acrylic polymer, and/or a silicone resin. The blended material may be coated, dried, and then cured on a removable film 103 to create a transfer film 105 then placed on the brake shim substrate 104 to create a brake shim layered construction. In some examples, the blended material 106 may be coated and cured directly onto the brake shim substrate 104 and a removable protective film 103 applied to create a damping shim layered material 102 that can be applied in various shapes and implementations such as in various brake systems. The removable film 103 may be removed and the brake shim material 102 applied to the surface of the brake system component that is transmitting the vibrations to be dampened.

Diagram 150 shows another example implementation, where the blended material 106 may be sandwiched (152) between two substrates 104. For example, two surfaces of the blended material may be formed as adhesive and disposed between two brake shim substrates.

Silicone polymers, also known as polysiloxanes, are polymers that may include any of a variety of synthetic compounds that include repeating units of siloxane. Siloxane is a chain of alternating silicon atoms and oxygen atoms, combined with one or more of carbon, hydrogen, and/or other elements. Polysiloxanes may be used in a variety of applications as a heat-resistant material, a sealant material, an adhesive material, a lubricant material, and/or as an insulative material. Silicone polymers may be formed by crosslinking a liquid polymer system, which forms an elastic gel, sets up, and solidifies. Silicone polymers can be cured through a variety of techniques including, but not limited to, condensation curing, platinum catalyzed curing, tin/zinc catalyzed curing, peroxide catalyzed curing, or room-temperature vulcanization. Temperature ranges of polysiloxanes may be adjusted based on what type of termination is used. For example, trimethylsiloxy terminated polydimethylsiloxane can be used in applications up to 480 deg F without breaking down, whereas aromatic groups (phenyl rings) can raise thermal stability to greater than 575 deg F. Polysiloxane polymers with reactive side group functionality such as vinyl, acrylate, epoxy, mercaptan or amine, may be used to create thermoset polymer matrix composites, coatings and adhesives.

Acrylic pressure sensitive polymers may be used in the manufacture of a pressure sensitive adhesives (PSAs). Acrylic monomers such as acrylic acid, methyl methacrylate, 2-ethyhexyl acrylate, butyl acrylate, and other monomers, which when polymerized may form permanently tacky acrylic polymers. Acrylic monomers may be polymerized in a reactor under heat, pressure, specific time and catalysts to produce an acrylic pressure sensitive polymer. With their higher resistance to heat and well bonding capability to polar surfaces such as metals, acrylic polymers may be used for pressure sensitive adhesive applications. Acrylic polymers may be derived from, for example, polyhydroxyethylmethacrylate, which can form a crosslinked polymer when treated with polyisocyanates.

Silicone resins are a type of silicone material which may be formed by branched, cage-like oligosiloxanes with the general formula of RnSiXmOy, where R is a non-reactive substituent, usually methyl or phenyl, and X is a functional group hydrogen, hydroxyl group, chlorine, or alkoxy group. These groups may be condensed to achieve highly crosslinked, insoluble polysiloxane networks. Silicone resins, with a molecular weight in the range of about 1000 g/mol to about 10,000 g/mol, may be used in pressure-sensitive adhesives, among other things. Silicone resins may be prepared by hydrolytic condensation of various silicone precursors. For example, tetraethoxysilane - (TEOS) or ethyl polysilicate and various disiloxanes may be used as starting materials for silicone resins.

Acrylic polymers tend to be more suitable for narrower temperature range applications at lower temperatures compared to silicone polymers and have higher loss factors. Thus, acrylic polymers properties may degrade outside of a narrower temperature range compared to silicon polymers. Depending on a type of acrylic polymer and/or its crosslinking, different peak temperatures may be achieved. In some examples, acrylic polymer, silicone polymer, urethane, and/or silicone resin may be blended in selected proportions to achieve a specific peak temperature and/or a temperature range. For example, larger proportions of silicone polymers relative to a proportion of acrylic polymer(s) may achieve a hybrid damping material with a broad temperature range of damping at a higher peak temperature compared to another hybrid material composed of a larger proportion of acrylic polymer(s), which may have a narrower temperature range at a lower peak temperature. By selecting specific acrylic polymers and/or their proportions in the blend of polymers, a targeted temperature region may be achieved in a noise/vibration damping application.

The individual solvated polymers may be selected to have similar molecular weight, and similar compatible solvents may be added to create similar viscosities such that a uniform stable blend of polymers can be produced that can be spread evenly on a substrate (e.g., a transfer film). For example, a solids concentration (% solids) value of the blended components may be within about 15% of one another. For enhanced stability, crosslinkers such as benzoyl peroxide or similar ones may also be added to the mixture. In some examples, a volumetric proportion of acrylic polymer to silicone polymer in the mixture may be in a range between about 5% and about 95%. In other examples, silicon resin may be mixed with acrylic polymer in a volumetric proportion of up to 30%.

In contrast, a conventional multi-layered damping material may include a stacked arrangement of layers, for example, a protective paper or film layer, a silicone layer, a brake shim core layer, an elastomer coating layer, an acrylic layer, and another protective paper or film layer.

The protective paper or film layers may be used for protection of the multi-layer damping material during storage and removed prior to assembly. The brake shim core layer may be made from cold rolled steel or other metal substrate. The silicone layer, the elastomer coating layer, and the acrylic layer may provide different damping characteristics (e.g., peak loss factor, peak loss factor temperature, damping efficiency temperature range, etc.). Each layer in a multi-layer damping material may require a series of processes to produce the layer and apply to another layer or a suitable substrate.

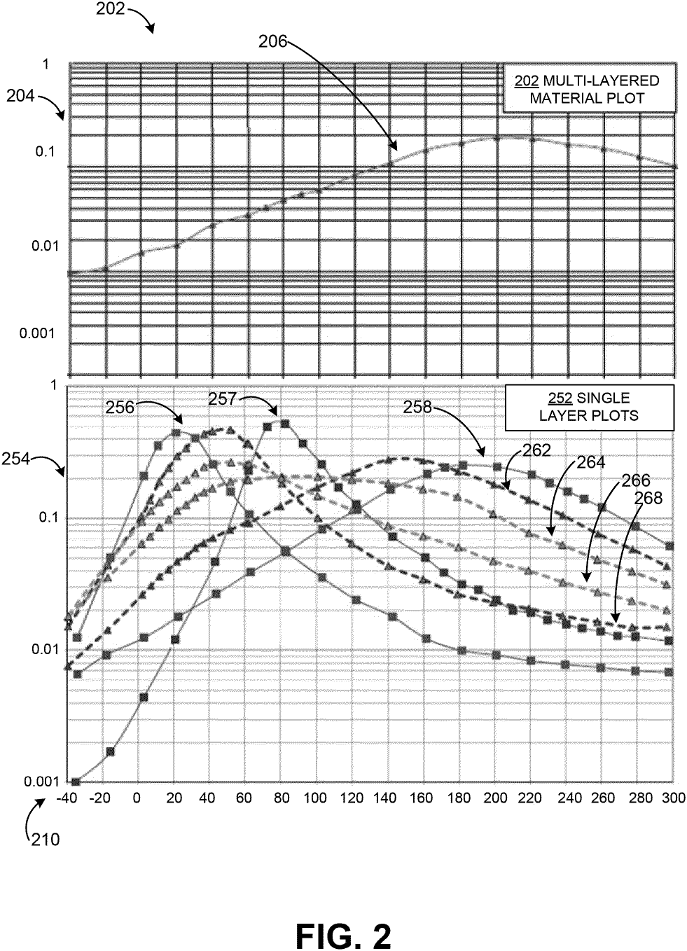

FIG. 2 illustrates example composite loss factor vs. temperature graphs for various hybrid acoustic damping material configurations, arranged in accordance with at least some embodiments described herein.

FIG. 2 includes a diagram 202 showing a composite loss factor plot 206 for an example multi-layered damping material over a temperature range. A vertical axis 204 of the diagram is a logarithmic representation of the composite loss factor as a relative number (highest number being “1”). A horizontal axis 210, shared by both diagrams 202 and 252 linearly represent temperature in degrees Fahrenheit. Based on the specific characteristics (material and thicknesses) of the individual layers of the material, the composite loss factor plot 206 is relatively broad over a temperature range of -40 deg F to 300 deg F compared to relatively narrow temperature ranges of, for example, 60 deg F or 100 deg F. A peak region of the plot is at about 200 deg F with a composite loss factor of about 0.02. “Relatively”, as used herein, may indicate a value or characteristic (e.g., breadth of a temperature range or value of loss factors) for one blend of polymers compared to another blend of polymers.

Diagram 252 shows loss factor vs. temperature plots 256, 257, 258, 262, 264, 266, and 268 for various polymers and blended hybrid materials. A vertical axis 254 of the diagram logarithmically represents the loss factor as a relative number (highest value being “1”), and the horizontal axis 210, as mentioned above, represents temperature in degrees Fahrenheit (deg F).

Plots 256, 257, and 258 represent loss factor characteristics of a cold acrylic polymer, an ambient temperature acrylic polymer, and a high heat silicone polymer, respectively. As illustrated by the plots 256, 257, and 258, acrylic polymers tend to have a narrower temperature range at lower temperatures (compared to silicone polymers) with higher loss factors, whereas high heat silicone polymer tends to have a broader temperature range with lower loss factors (compared to the acrylic polymers). The temperature range, as used herein, refers to a range of temperatures over which the hybrid material (or a polymer) exhibits its damping characteristics. Outside of the temperature range, the polymer(s) may start becoming too stiff or too soft and damping characteristics may begin to fade. In brake system implementations, the material (or polymers) may begin at ambient temperature, but as the brakes heat up (due to friction as explained below), an internal temperature of the hybrid material may increase.

A first example blend may include a solvated silicone polymer with about 47% solids in Toluene and MEK (e.g., A2-292-24 by WOLVERINE ADVANCED MATERIALS) and a solvated acrylic polymer with about 46% solids in Toluene and MEK (e.g., SC145 by 3 SIGMA COMPANY) at a proportion of about 75% / 25% by volume. A second example blend may include a solvated acrylic/urethane polymer with about 35% solids in Toluene and MEK (e.g., SC710 by 3 SIGMA COMPANY) and a solvated silicone resin with about 60% solids in Toluene and MEK (e.g., SR545 by MOMENTIVE PERFORMANCE MATERIALS COMPANY) at a proportion of about 75% / 25% by volume. A third example blend may include a solvated silicone polymer with about 47% solids in Toluene and MEK (e.g., A2-292-24 by WOLVERINE ADVANCED MATERIALS) and a solvated acrylic/urethane polymer with about 35% solids in Toluene and MEK (e.g., SC710 by 3 SIGMA COMPANY) at a proportion of about 70% / 30% by volume. A fourth example blend may include a solvated silicone polymer with about 47% solids in Toluene and MEK (e.g., A2-292-24 by WOLVERINE ADVANCED MATERIALS) and a solvated acrylic/urethane polymer with about 35% solids in Toluene and MEK (e.g., SC710 by 3 SIGMA COMPANY) at a proportion of about 60% / 40% by volume.

Plot 262 represents the loss factors of the first example blend of polymers over temperature. Reduced damping of the first example blend of polymers occurs, outside of a relatively broad temperature range (compared to other example blends of polymers) and damping efficiency of the material begins to drop. The loss factors peak at about 0.3 around 150 deg F. Plot 264 represents the loss factors of the third example blend of polymers over temperature. The third example blend of polymers exhibits reduced damping outside of a relatively broad temperature range with the loss factors peaking at about 0.2 between about 60 deg F and about 140 deg F. Plot 266 represents the loss factors of the fourth example blend of polymers over temperature. The fourth example blend of polymers exhibits reduced damping outside of a relatively narrow temperature range with the loss factors peaking at about 0.28 around 50 deg F. Thus, the fourth example blend of polymers may be used for a hybrid damping material with a targeted operating temperature range. Plot 268 represents the loss factors of the second example blend of polymers, where the polymers exhibit reduced damping outside of a relatively narrow temperature range (similar to the third example blend of polymers) with the loss factors peaking at about 0.48 around 50 deg F. A peak loss factor, a temperature range for the peak loss factor, and an operating temperature range (outside of which the polymers exhibit reduced damping) may be selected based on the types and proportions of the individual polymers used in the blend of polymers.

Other examples, not shown in the plots, but verified through experimentation, may include an example blend with a solvated silicone polymer with about 47% solids in Toluene and MEK (e.g., A2-292-24 by WOLVERINE ADVANCED MATERIALS) and a solvated acrylic polymer with about 45% solids in Toluene and MEK (e.g., SC844 by 3 SIGMA COMPANY) at a proportion of about 70% / 30% by volume. This example blend may have a peak loss factor of about 0.15 at about 100 deg F. Another example blend may include a solvated acrylic polymer with about 46% solids in Toluene and MEK (e.g., SC145 by 3 SIGMA COMPANY) and a solvated silicone resin with about 60% solids in Toluene and MEK (e.g., SR545 by MOMENTIVE PERFORMANCE MATERIALS COMPANY) at a proportion of about 90% / 10% by volume. This other example blend with silicone resin may have a peak loss factor of about 0.3 at about 40 deg F.

The single layer of the hybrid acoustic damping material, which can be uniformly applied with standard equipment and processes, may allow preparation steps for the individual layers to be reduced. By selecting composition characteristics and proportions of the individual polymers in the blend of polymers, a broad loss factor over a wide temperature range may be achieved. Alternatively, narrower temperature ranges with higher loss factors may be achieved for specific applications by selecting composition characteristics and proportions of the blended materials.

While examples such as specific silicone or acrylic polymers, application environments (e.g., brake systems), polymer characteristics, loss factor and temperature ranges are used for illustration purposes, embodiments are not limited to the illustrative examples. Other silicone or acrylic polymer types and characteristics (e.g., % solids), as well as, application environments may be used without departing from the principles described herein.

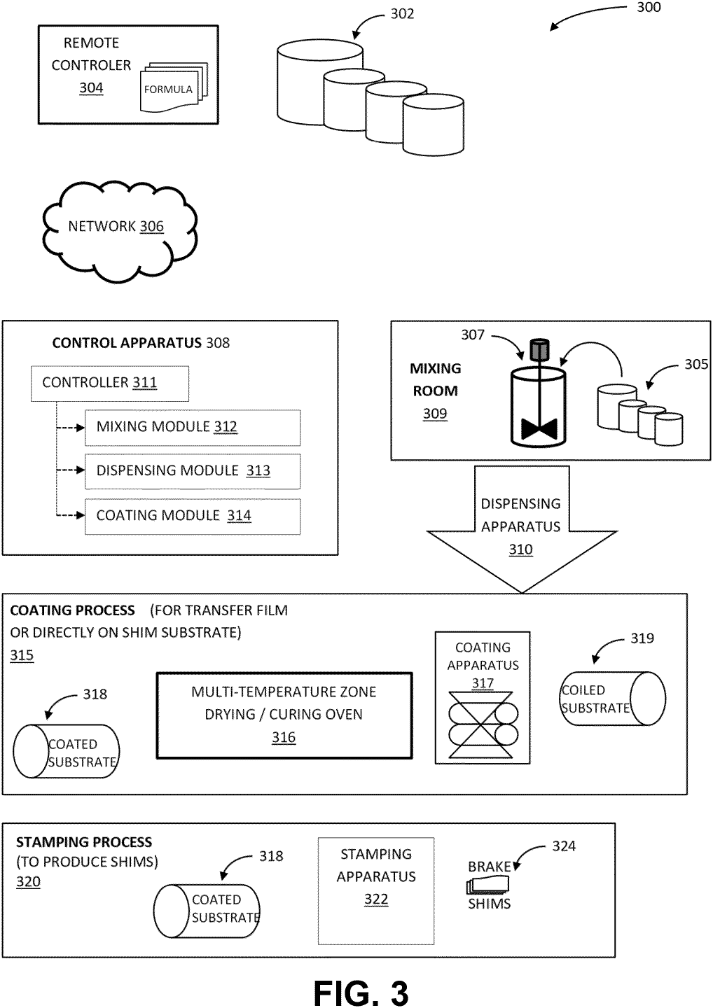

FIG. 3 illustrates an example production system to produce hybrid acoustic damping materials, arranged in accordance with at least some embodiments described herein.

Example system 300 shown in FIG. 3 may include a control apparatus 308, that may include a mixing module 312, a dispensing module 313, and a coating module 314 among other modules and/or engines. Control apparatus 308 may further include a controller 311, which is coupled to one or more of mixing module 312, dispensing module 313, and/or coating module 314. In some examples, system 300 may further include one or more data stores 302 and remote controller 304, which may be communicatively coupled to the control apparatus 308 via network 306. Mixing module 312 may control operations of a mixing room 309, which may include a mixer 307 and polymer (and/or crosslinker) containers 305. Dispensing module 313 may control operations of a dispensing apparatus 310. Coating module 314 may control a coating process 315 and a stamping process 320. The coating process 315 may include a coiled substrate 319 fed into a coating apparatus 317. A multi-temperature zone or drying/curing oven 316 may cure the coiled substrate 319 coated by the coating apparatus 317 resulting in coated substrate 318. The stamping process 320 may take the coated substrate 318 and produce brake shims 324 with the hybrid damping material through stamping apparatus 322.

The one or more data stores 302 may be adapted to store operating instructions and/or data as may be required for operation of control apparatus 308. The one or more data stores 302 may be coupled to control apparatus 308 via a direct connection or an indirect connection. In some examples, the one or more data stores 302 may be coupled to control apparatus 308 via a network 306. In still other examples, the one or more data stores 302 may be coupled to control apparatus 308 via a remote controller 304; where the remote controller may be coupled to control apparatus 308 via a network 306. The controller 311 may be adapted to control operation of the various modules via operating instructions and/or data. Although illustrated as modules, one or more of the illustrated modules 312, 313, and 314 may be separate devices within control apparatus 308; or integrated together as logical modules within the control apparatus 308.

In some examples, the one or more data stores 302 may be integrated into the control apparatus 308 as a physical module, or as a logical module within the control apparatus 308. Data and programs associated with producing the hybrid acoustic damping material, in particular, formulas of the blended polymers, parameters of a production process to blend and form the hybrid material may be stored at and/or received from the one or more data stores 302. Networkable devices may be operated by human control at the remote controller 304 via the network 306, or by machine executed instructions, such as might be found in a computer program. Furthermore, the remote controller 304 and the controller 311 may be implemented as separate controller devices such as special-purpose or general-purpose computing devices, as a micro-processor, as a micro-controller, or as a circuit adapted to control the modules. The network 306 may facilitate communication between the remote controller 304 and the apparatus 308 as through wired and/or wireless media such as acoustic, radio frequency (RF), microwave, infrared (IR) and other wireless media.

The individual modules of the control apparatus 308 may each include multiple distinct devices. A number and type of such devices may be selected and some of the devices may be replaced or eliminated based on specific implementations. The modules and their devices may be electrically, communicatively, and fluidically coupled depending on their type and use. The modules and their devices may be controlled individually or in groups by the controller 311 or by the remote controller 304.

According to additional examples, the mixing module 312 may be configured (e.g., via machine executable instructions from controller 311) to select quantities of materials (e.g., in containers 305) to be combined for the hybrid material or receive instructions and/or data from data store 302 to identify the quantities of materials to be selected. The mixing module 312 may then affect mixing of the selected quantities of the solvated materials such as silicone polymer, acrylic polymer, urethane, silicone resin, etc. in the mixer 307. The mixing module 312 may also add additional chemicals such as a crosslinker, a catalyst, a preservative, or similar ones. In another example, the mixing module 312 may modify parameters during the blending to achieve a uniform stable blend that can be spread evenly and has the intended composite loss factor and temperature characteristics. The parameters may include a type of injector used in the mixing process, a type of the materials to be mixed, an injection rate, a timing of the mixing, and/or a type of mixing (e.g., rotation, shaking, etc.).

The dispensing module 313 may include a number of interconnected devices such as material storage containers, dispensers (e.g., injectors), mixers, as well as, environmental control devices such as heaters, coolers, humidifiers, de-humidifiers, pumps, valves, recirculators, etc. The interconnected devices are represented in the figure as dispensing apparatus 310.

Then, the coating module 314 may control the coating apparatus 317 and parameters such as wet coating thickness, temperature, and viscosity; or control the curing of the coated blend of polymers, for example, by exposing to heat and/or radiation (e.g., infrared, near-infrared, ultraviolet, visible spectrum light), or over time in separate temperature zones within the multi-temperature zone drying/curing oven 316. Environmental parameters such as temperature, humidity, lighting levels, etc. may be controlled by the coating module 314 during the coating process 315. As such, the coating module 314 may control devices such as a coating box or coating rollers, a heater, a cooler, an air blower, a light source, etc. The coating module 314 may also control a thickness of the hybrid material based on intended damping characteristics and types of components blended together. The coating module may control covering the cured hybrid acoustic damping material with a protective film or paper on one side or both sides for storage and shipping; or it may apply the hybrid acoustic damping material as a transfer film instead of a liquid application.

The coating module 314 may also control shaping, packaging, and other preparations of the hybrid acoustic damping material. The cured hybrid acoustical damping material coated coil material may be cut to different sizes and shapes based on intended applications in the stamping process 320. For example, a sheet of cured hybrid acoustical damping coated material (coated substrate 318) may be cut to different sizes and shapes of brake shims 324 by the stamping apparatus 322.

The examples in FIGS. 2 and 3 have been described using specific compositions, apparatuses, configurations, and systems to produce a hybrid acoustic damping material. Embodiments are not limited to the specific compositions, apparatuses, configurations, and systems according to these examples.

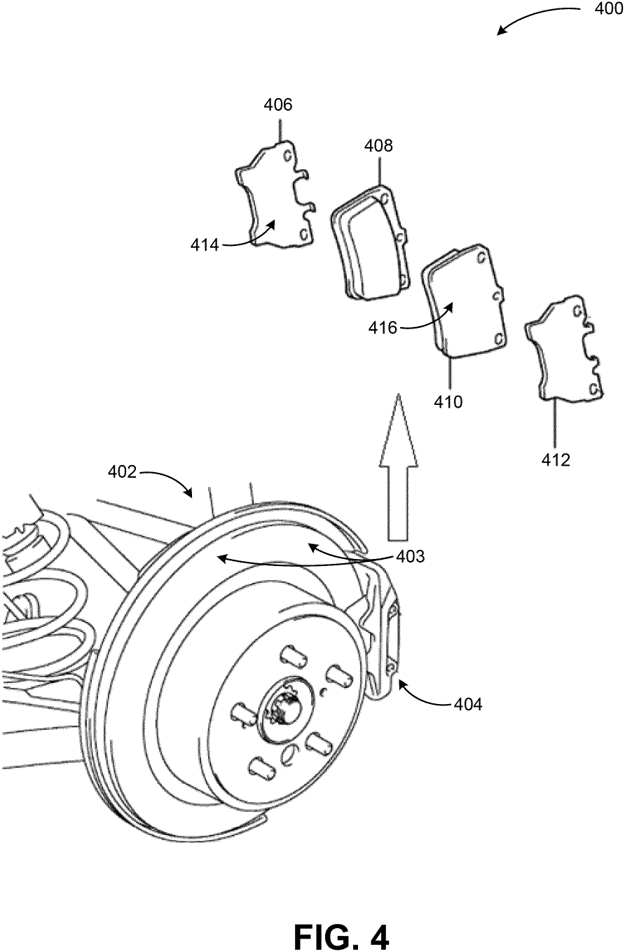

FIG. 4 illustrates an example disk brake, where hybrid acoustic damping materials is used to mitigate noise and vibration, arranged in accordance with at least some embodiments described herein.

As shown in diagram 400, a disk brake 404 is positioned on a portion of a disk 402 of a vehicle’s wheel and includes, among other things, an inner pad 408, an outer pad 410, an inner anti-squeal shim 406, and an outer anti-squeal shim 412.

In an operation, the disk brake 404 is activated through a hydraulic system in the vehicle (not shown), which causes the inner pad 408 and the outer pad 410 to be moved toward each other pressing on the inner and outer surfaces of the disk 402. The friction caused between the pads 408 and 410 and respective surfaces of the disk converts the kinetic energy of the rotating wheel into heat, slowing the rotation of the wheel and thus slowing the vehicle down. The inner pad 408 and the outer pad 410 may be made from a ceramic, composite, or a combination metal material (e.g., iron, copper, steel and graphite).

As the brake pads 408 and 410 and the disk surfaces 403 (and the opposite side) come into contact (e.g., urged against each other by the brake operation) vibration and noise (e.g., squealing, scraping, shuddering, or whining noises) may be generated. In accordance with the present disclosure, a hybrid material may be applied to an inside surface 414 of either the inner anti-squeal shim 406 (and corresponding inner surface of the outer anti-squeal shim 412) and/or an outer surface 416 of the outer anti-squeal shim 412 (and corresponding outer surface of the inner anti-squeal shim), or exist as an inner layer of a sandwich constructed anti-squeal shim, to mitigate the vibration and noise that may otherwise be generated.

As discussed above, the brake system converts kinetic energy to heat energy. Thus, the brake pads may begin to build up heat as the brakes are applied and operate in over a broad temperature range (e.g., from ambient temperature to about 400 deg F). Therefore, the hybrid damping material may be desired to have particular a composite loss factor over the operating temperature range of the brake system, that is, the polymers of the hybrid damping material may be allowed to break down outside of the operating temperature range of the brake system. On the other hand, the operating temperature range may vary between different brake types, materials, and vehicle types. For example, light weight vehicle (e.g., passenger car) brakes may operate at a lower temperature range compared to heavy weight vehicle (e.g., truck) brakes, or ceramic brake pads may operate at higher temperatures compared to metallic brake pads. Thus, types of component polymers and their proportions in the blend of polymers may be selected to correspond to the desired temperature characteristic of the hybrid material for a particular application.

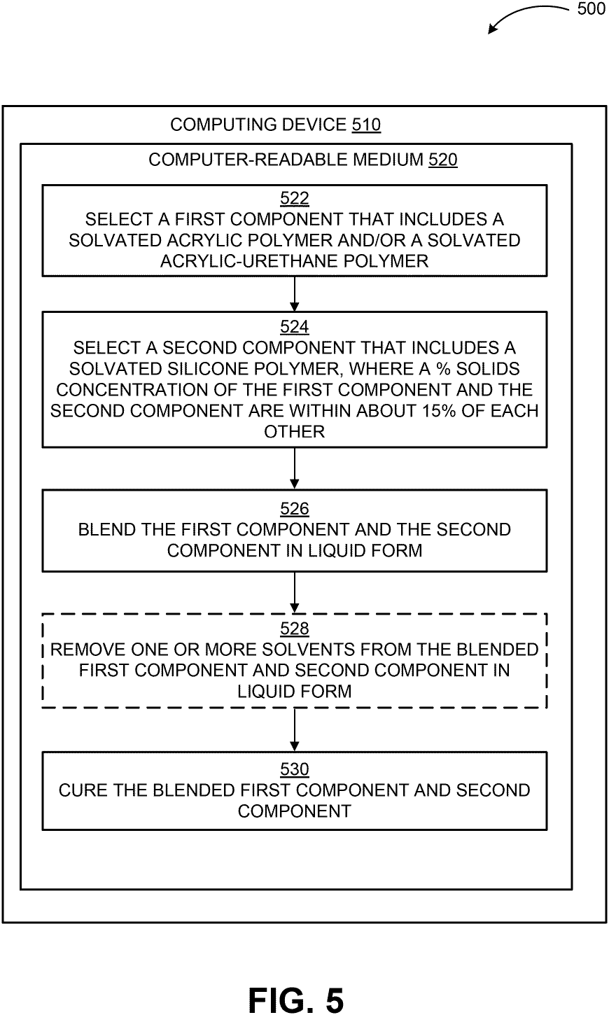

FIG. 5 illustrates a flowchart for production of an example hybrid acoustic damping material, arranged in accordance with at least some embodiments described herein.

Example methods may include one or more operations, functions or actions as illustrated by one or more of blocks 522, 524, 526, 528, and 530, and may in some embodiments be performed by a computing device or may be performed by an apparatus controlling operations of a system such as the one described in FIG. 3. The operations described in the blocks 522-530 may also be stored as computer-executable instructions in a computer-readable medium such as a computer-readable medium 520 of a computing device 510.

An example process to produce a hybrid acoustic damping material may begin with block 522, “SELECT A FIRST COMPONENT THAT INCLUDES A SOLVATED ACRYLIC POLYMER AND/OR A SOLVATED ACRYLIC-URETHANE POLYMER,” where a solvated acrylic or acrylic-urethane polymer component for the hybrid acoustic damping material is selected. Based on intended peak temperature range and value for the composite loss factor (damping efficiency), as well as, whether a targeted temperature range is desired or a broad temperature range is desired (for loss factors above a particular threshold), an amount of the first component may also be determined.

Block 522 may be followed by block 524, “SELECT A SECOND COMPONENT THAT INCLUDES A SOLVATED SILICONE POLYMER, WHERE A % SOLIDS CONCENTRATION OF THE FIRST COMPONENT AND THE SECOND COMPONENT ARE WITHIN ABOUT 15% OF EACH OTHER,” where a solvated silicone polymer component for the hybrid acoustic damping material is selected. A solid concentration (% solids) of the first component and the second component may be selected within about 15% of each other such that the components blend and do not gel or otherwise separate. For example, solid concentration of the polymer components may be in a range from about 30% to about 50%.

Block 524 may be followed by block 526, “BLEND THE FIRST COMPONENT AND THE SECOND COMPONENT IN LIQUID FORM,” where selected components may be blended, for example, in a mixer. In some examples, a crosslinker, a catalyst, and/or a preservative may also be added to the blend.

Block 526 may be followed by optional block 528, “REMOVE ONE OR MORE SOLVENTS FROM THE BLENDED FIRST COMPONENT AND SECOND COMPONENT IN LIQUID FORM,” where any solvents that may not have vaporized may be removed from the blend.

Optional block 528 may be followed by block 530, “CURE THE BLENDED FIRST COMPONENT AND SECOND COMPONENT,” where the blended materials may be cured. In some examples, the blended materials may be dispensed onto a removable film and cured on the removable film to form a transfer film, which may then be applied to the sheet of brake shim substrate before forming (stamping), or be cut to shape and applied to a shim (in brake system applications). An example of the curing process may include drying at 200° F. for about 3 minutes (or less) and curing at 320° F. for another 3 minutes (or less). An example wet film may be about 0.20 mm thick and the corresponding dry film following the curing process may be about 0.06 mm thick.

Blending and formation of a hybrid acoustic damping material according to examples may include addition of reactants, solvents, and/or catalysts, which may include, but is not limited to, methyl benzoyl peroxide, urethane derivatives, and comparable ones.

In some examples, a computer program product may include a signal-bearing medium that may also include one or more machine readable instructions that, when executed by, for example, a processor may provide the functionality described above. Thus, for example, a system such as the one described in FIG. 3 may undertake one or more of the operations shown in FIG. 5 in response to the one or more machine readable instructions conveyed to the control apparatus 308 by the signal-bearing medium to perform actions associated with producing a hybrid acoustic damping material as described herein.

In some implementations, the signal-bearing medium may encompass computer-readable medium, such as, but not limited to, a hard disk drive, a solid-state drive, a compact disc (CD), a digital versatile disk (DVD), a digital tape, memory, etc. In some implementations, the signal bearing medium may encompass recordable medium, such as, but not limited to, memory, read/write (R/W) CDs, R/W DVDs, etc. In some implementations, the signal-bearing medium may encompass a communications medium, such as, but not limited to, a digital and/or an analog communication medium (e.g., a fiber optic cable, a waveguide, a wired communications link, a wireless communication link, etc.). Thus, for example, the computer program product may be conveyed to one or more modules of the control apparatus 308 by an RF signal bearing medium, where the signal-bearing medium is conveyed by the communications medium (e.g., a wireless communications medium conforming with the IEEE 802.11 standard).

Following are examples scenarios with specific exemplary implementations.

### Example 1

In one example scenario, a hybrid acoustic damping material may be produced by blending a silicone polymer with 47% solids in Toluene and MEK (e.g., A2-292-24 by WOLVERINE ADVANCED MATERIALS) and an acrylic polymer with 46% solids in Toluene and MEK (e.g., SC145 by 3 SIGMA COMPANY) at a proportion of 75% / 25% by volume. The materials may be blended at room temperature, disposed on a film substrate, the solvents removed, and cured to create a transfer film with an adhesive thickness of 0.91 mm for disk brake applications. The hybrid material may be applied directly to an inside surface of an anti-squeal shim using the transfer film prior to stamping into the shim shape. The loss factor of the hybrid material may peak around 0.28 at about 30 deg F.

### Example 2

In another example scenario, a hybrid acoustic damping material may be produced by blending an acrylic polymer with 35% solids in Toluene and MEK (e.g., SC710 by 3 SIGMA COMPANY) and a silicone resin with 60% solids in Toluene and MEK (e.g., SR545 by MOMENTIVE PERFORMANCE MATERIALS COMPANY) at a proportion of 75% / 25% by volume. The materials may be blended at room temperature and cured on a transfer film with a thickness of 0.91 mm for metal disk brake applications for small vehicles. The hybrid material may be applied to an inside surface of an anti-squeal shim directly or using the transfer film prior to stamping. The loss factor of the hybrid material may peak around 0.5 at about 45 deg F.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1-23. (canceled)

24. A method of forming an apparatus, comprising:
providing a substrate;
forming a blended polymer, comprising:
providing an acrylic polymer or an acrylic-urethane polymer in a first solvent,
providing a silicone polymer in a second solvent, and
blending the acrylic and silicone polymers;
applying the blended polymer to the substrate; and
curing the blended polymers to form an adhesive layer.

25. The method of claim 24, wherein:
the acrylic polymer or the acrylic-urethane polymer is solvated in the first solvent; and
the silicone polymer is solvated in the second solvent.

26. The method of claim 24, wherein:
the acrylic polymer is solvated at a first solids concentration;
the silicone polymer is solvated at a second solids concentration, and
the first and second solids concentrations are within 15% of each other.

27. The method of claim 25, wherein:
the first and second solids concentration are each between 30% and 50%.

28. The method of claim 24, wherein the substrate comprises a transfer film substrate, the method further comprising:
providing a brake shim substrate; and
applying the adhesive layer to the brake shim substrate.

29. The method of claim 28, further comprising:
removing the transfer film substrate.

30. The method of claim 24, wherein the silicone polymer comprises up to 30 volume % of the blended polymer.

31. The method of claim 30, wherein the silicone polymer comprises 25 volume % of the blended polymer.

32. The method of claim 24, wherein each of the first and second solvents comprise one or both of toluene and MEK.

33. The method of claim 24, wherein curing the blended polymers comprises heating the blended polymers at an elevated temperature.

34. A method of forming a hybrid acoustic damping material, comprising:
providing a first component comprising an acrylic polymer or an acrylic-urethane polymer solvated in a first solvent at a first solids concentration;
providing a second component comprising a silicone polymer solvated in a second solvent at a second solids concentration, wherein the first and second solids concentrations are within 15% of each other;
blending the first and second components; and
curing the blended first and second components.

35. The method of claim 34, further comprising:
before curing the blended first and second components, removing a solvent from the blended first and second components.

36. The method of claim 34, wherein the solvated acrylic polymer comprises a solvated acrylic-urethane polymer.

37. The method of claim 34, wherein the solvated silicone polymer comprises a polysiloxane polymer.

38. The method of claim 34, wherein the solvated silicone polymer comprises an oligosiloxane polymer.

39. The method of claim 34, wherein blending the first and second components together comprises blending the first and second components such that a volumetric proportion of the second component to the first component is between about 5% and about 95%.

40. The method of claim 39, wherein the volumetric proportion of the second component to the first component is between 5% and 30%.

41. The method of claim 34, wherein the first solvent comprises at least one of toluene and MEK.

42. A method of forming an apparatus, comprising:
providing a substrate;
providing a first polymer in a first solvent at a first solids concentration;
providing a second polymer in a second solvent at a second solids concentration,
wherein a difference between the first and second solids concentration is 15% or less;
blending the first and second polymers together;
applying the blended first and second polymers to the substrate; and
curing the blended first and second polymers to form an adhesive layer.

43. The method of claim 42, wherein the substrate comprises a transfer film substrate.

44. The method of claim 43, further comprising:
providing a brake shim substrate; and
applying the adhesive layer to the brake shim substrate.

45. The method of claim 44, wherein the transfer film substrate is attached to a first surface of the adhesive layer and the brake shim substrate is applied to a second surface of the adhesive layer, the method further comprising:
removing the transfer film substrate from the first surface of the adhesive layer.

46. The method of claim 45, wherein the brake shim substrate comprises a first brake shim substrate, the method further comprising:
providing a second brake shim substrate; and
applying the first surface of the adhesive layer to the second brake shim substrate such that the adhesive layer is positioned between the first and second brake shim substrates.
